(19) United States
(12) Patent Application Publication
(10) Pub. No.: US 2005/0044065 A1
(43) Pub. Date: Feb. 24, 2005

(54) Method and apparatus for enabling national language support of a database engine

(75) Inventor: James Michael McArdle, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/645,039

(22) Filed: Aug. 21, 2003

(51) Int. Cl. G06F 17/30

(52) U.S. Cl. 707/3

(57) ABSTRACT

A method and apparatus for enabling NLS of a database engine. A new feature is added to the database engine, which allows the user to define a language or locale setting when he or she first connects to the database engine. The message tables in the database engine dynamically adapts to the setting. The language or locale setting becomes an implicit table key whenever the message table is used.

### BACKGROUND OF THE INVENTION

1. Technical Field

The present invention relates generally to an improved data processing system and in particular to database engines used in data processing systems. Still more particularly, the present invention provides a method, apparatus, and computer instructions to enable language support in a database engine.

2. Description of Related Art

The use of electronic business over the Internet by consumers has increased in the recent years. The concept of electronic commerce has expanded to not just across the United States, but also throughout the world. This sparks the requirement of a multilingual and multicultural database that can handle various languages and locales associated with various regions of the world.

Currently, the primary method companies use to confront this situation is by using locale specific servers to handle regional transactions. Companies also employ complex business logic programs to merge the data in order to form global business reports. This method results in duplication of workforce in order to manage the database within each region.

In existing literatures, various approaches have been suggested to support the internationalization of data. One of the approaches is to modify features of the database engine to handle Unicode characters. Unicode provides a unique number for every character, no matter what the platform, no matter what the program, and no matter what the language. Unicode is supported in many operating systems, all modern browsers, and many software products. A database engine can handle Unicode either by using direct Unicode, a UTF-8, or UTF-16 encoding of Unicode.

A database engine that handles Unicode characters is called a Unicode database. Although a Unicode database has advantages, this type of database also has drawbacks. For example, if an analyst wants to see text data in the analyst's native locale from the Unicode database by using a query tool, multiple translations of the text data have to be stored in separate tables. These tables contain the following: an index value for the text, a locale value, and the translated text description written for that locale. For example, a customer id (text index value), a locale id (locale value) and a customer name (translated text description). Furthermore, the analyst has to enter additional locale id for each text field needed. This situation often is a cumbersome task for the analyst. Also, the query time required for the query tool in order to join these separate tables can be very long in an enterprise level database such as DB2 Universal Database, a product from IBM Corporation, since this type of databases can have more than 10 million records.

In general, most industry query tools favor the use of star schema over snowflake schema. A star schema is a set of tables where one table is the central table; the central table references other tables through an id or a code. A star schema facilitates multidimensional data modeling, which enable an analyst to view data from different perspectives. For example, data can be queried from a customer's perspective or sales representative's perspective. A snowflake schema, on the other hand, is a set of tables in which the central table references other tables and the other tables in turn reference other tables. The snowflake schema is a normalized version of the star schema with more table joins required in order to retrieve information. Due to the necessity of national language support (NLS) introduction in the database engine, a snowflake schema may result. NLS is used to establish the language environment of a system by using system variables. In addition to the system variables, NLS provides commands, files, and other tools to allow programs of a user's system to access locale information at run time so that data is processed and displayed correctly according to user's cultural conventions and language.

In order to support NLS in the database engine, the locale setting has to be associated with every aspect of the query; this association makes the query longer. In addition, the locale setting is dependent on the analyst's locale at login time. By using a locale setting, the translation tables are joined with the user tables to produce a locale specific set of user tables. If multiple locales are present, the process of joining results in a significantly large database to store data for these locales. As a result, performance of the database engine suffers as more tables are joined.

As shown in the above example approach, no existing solution is present that currently provides the ability to dynamically build and analyze multilingual and multicultural Unicode databases without placing a burden on the analyst and the query tool. In addition, no existing solution is available to provide support of NLS in the database engine for multidimensional modeling without impacting the performance of the database engine during execution. The performance of the database engine is impacted because of the requirements for additional conditions in queries and tables associated for each language or locale.

Therefore, it would be advantageous to have an improved method, apparatus, and computer instructions for enabling NLS support of a database engine in a manner that minimizes the need for a user to adjust underlying queries and tables for each language or locale. In addition it also would be advantageous to have an improved method, apparatus, and computer instructions that minimizes impact to the performance of the database engine as the number of languages and locales increase in the database engine.

### SUMMARY OF THE INVENTION

The present invention provides a method, apparatus, and computer instructions for enabling NLS support of the database engine such as the DB2 Universal Database, a product by IBM Corporation. The innovative tool can be added as a new feature to existing database engines. The innovative tool, in the preferred embodiment, allows users to define a language or locale setting when users connect to the database engine. This language or locale setting, in turn is used implicitly in all references to the message tables. The present invention provides a method to support NLS by minimizing the number of explicit NLS conditions required on a given query or related queries; and by reducing the complexity of these queries for multiple languages or locales. In addition, the innovative tool provides mechanisms to support multidimensional modeling by enhancing the query grammar to include additional conditions automatically.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system is shown in which the present invention may be implemented;

FIG. 3A is a diagram illustrating components used in enabling NLS of a database engine in accordance with a preferred embodiment of the present invention;

FIG. 3B is a diagram of database and table structure for enabling NLS of a database engine is in accordance with a preferred embodiment of the present invention;

FIG. 4A is a diagram of components used in enabling NLS of a database engine by changing SQL command line processor to handle NLS in accordance with a preferred embodiment of the present invention;

FIG. 4B is a diagram of database and table structure for enabling NLS of a database engine in accordance with a preferred embodiment of the present invention;

FIG. 5 is a flowchart of a process used in enabling NLS of a database engine by changing internal operation of the database engine to handle NLS in accordance with a preferred embodiment of the present invention;

FIG. 6 is a flowchart of processing for modifying the SELECT query statement in accordance with a preferred embodiment of the present invention;

FIG. 7 is a flowchart of a process used in enabling NLS of a database engine by changing SQL command line processor to handle NLS in accordance with a preferred embodiment of the present invention; and

FIG. 8 is a flowchart of processing for processing the SELECT query statement in accordance with a preferred embodiment of the present invention.

### DETAILED DESCRIPTION OF THE PREFERRED EMBODIMENT

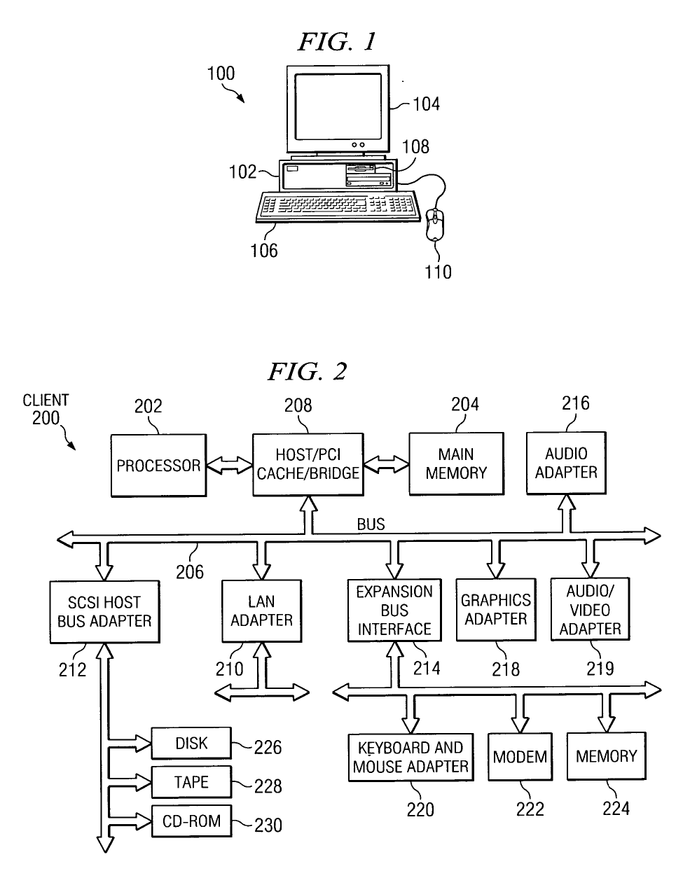

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a method, apparatus, and computer instructions for enabling language support of the database engine, such as the DB2 Universal Database, a product by IBM Corporation. In these examples, the language support is directed towards NLS. The innovative tool can be added as a new feature to existing database engines. The innovative tool of the present invention allows users to define a language or locale setting when users connect to the database engine. This language or locale setting, in turn is used implicitly in all references to the message tables. In other words, the language or locale setting is automatically added to the references. As used herein, using the language or locale setting implicitly or adding the language or locale setting implicitly means that the setting is automatically added.

The present invention provides a method to support NLS by minimizing the number of explicit NLS conditions required on a given query or related queries; and by reducing the complexity of these queries for multiple languages or locales. In addition, the present invention provides mechanisms to support multidimensional modeling by enhancing the query grammar to include additional conditions automatically.

Currently, when a user wants to retrieve data from the database engine with respect to a particular language or locale, the user has to add additional expressions to the select statement of the structured query language (SQL) query where clauses to define the language or locale setting. The two additional conditions needed in every message table are the message number key and a language or locale key. SQL is an American National Standards Institute (ANSI) standard computer language for accessing and manipulating database systems. SQL query statements are used to retrieve and update data in a database.

Another strategy a user may use to retrieve data for a particular language or locale from the database engine is to create a view on the message table where the language or locale key is fixed. In this case, the user is only required to specify the message number key. However, neither of these two approaches completely solves the problem because once the schema of the database engine is defined for all users of the database engine, a user may not change it.

In contrast, the present invention provides a more dynamic mechanism in which an SQL statement is used to set the language or locale preference on a per user basis when a user first connects to the database engine. The locale setting establishes a proper user environment for sorting, comparison, date and time in the database engine. The mechanism of the present invention defines one or more new data types in the database engine whose values will be depended upon the setting of the language or locale preference by the user. These data type values will be reference globally by the SQL query statements described by the present invention.

In one example, the mechanism of the present invention does not require the user to set up properties in a form of a file outside the database engine prior to connecting to the database engine. For example, a properties file used in the Java ResourceBundles. Java trademark of Sun Microsystems, Inc.

Further, the mechanism of the present invention also does not require any user modification to the query pertaining to a specific language or locale. For example, adding a locale id condition in the where clause of the SQL query statement. However, in a one embodiment of the present invention, the language or locale preference is required from the user. For example, “enus”, which represents U.S. English. In addition, in the depicted examples, the user is required to provide a query containing the table column name for the requested data and the message table name in the database engine that is not specific to a language or locale to retrieve, update or delete requested data. For example, the table column name “Cityname” and the table name “Citynames”. The message table is created by the user prior to the execution of the user query.

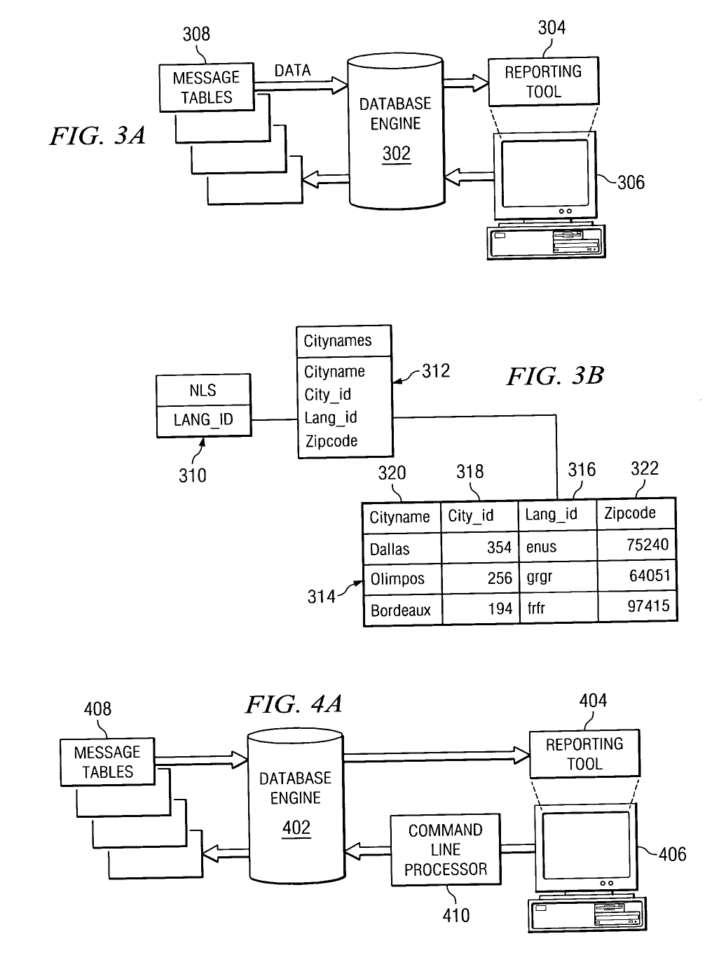

Turning now to FIG. 3A, a diagram illustrating components used in enabling NLS of a database engine is depicted in accordance with a preferred embodiment of the present invention. As depicted in FIG. 3A, in this example implementation, a user runs a reporting or query tool 304 on data processing system 306, which corresponds to data processing system 200 described in FIG. 2.

When a user connects to the database engine 302, the user sets the language or locale preference. The language or locale selected by the user setting is then maintained by the database engine 302. Each user connecting to database engine 302 may set a language or locale. When the user presents a query to the database engine for execution to retrieve data, the proper message table or tables from message tables 308 are selected by database engine 302 based upon the language or locale setting maintained for the user. Message tables 308 contain data that are requested by the user on a particular language or locale. Finally, from executing the query, presented by the user, resulting data is returned by database engine 302 to reporting or query tool 304.

Turning next to FIG. 3B, a diagram of database and table structure for enabling NLS of a database engine is depicted in accordance with a preferred embodiment of the present invention. This database and table structure is implemented using the components of the present invention as described in FIG. 3A.

As shown in FIG. 3B, the language or locale setting selected by the user when the user connects to the database engine, in this example “enus”, is stored in the LANG_ID. LANG_ID is the value of NLS Specific entity 310 that is defined by the present invention. Entity 310 is referenced by the user queries throughout the database engine. When the user sends a query to request data for a specific locale or culture, in the above example “enus”, the mechanism of the present invention implicitly adds the additional condition to the SQL query statement prior to sending the value for reference in the message table. For this example, “Lang_id” table column in the “Citynames” message table structure 312 is defined to reference the LANG_ID NLS specific entity maintained in the database engine 310.

The mechanism of the present invention implicitly adds additional conditions in the WHERE clause of the user query to reference the values stored in “Lang_id” table column of the “Citynames” message table 314. In this example, column 316 contains the language ID, column 318 contains the message ID in the form of a city ID, the city name is located in column 320, and the zip code is located in column 322.

When the query is executed, the mechanism of the present invention enables the selection of the specific locale by utilizing the LANG_ID reference in the message table 314 to store multiple locale settings in multiple rows. In turn, the mechanism minimized the number of tables required for different locales.

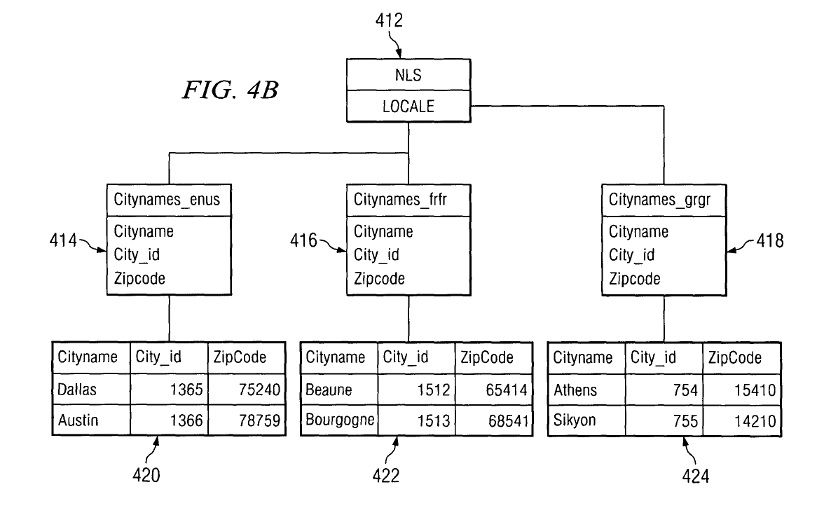

Turning next to FIG. 4A, a diagram of components used in enabling NLS of a database engine by changing SQL command line processor to handle NLS is depicted in accordance with a preferred embodiment of the present invention. As shown in FIG. 4A, in this example implementation, SQL command line processor 410 is used as the front end to database engine 402 to interact with reporting or query tool 404. The user runs reporting or query tool 404 on data processing system 406, which may be implemented using a data processing system, such as data processing system 200 in FIG. 2.

When a user connects to database engine 402, the user sets the language or locale preference. Instead of sending the language or locale setting directly to the database engine like the previous example, the SQL command line processor 410 accepts and stores the setting. When the user presents a query to database engine 402 for execution to retrieve data, SQL command line processor 410 scans the query and adjusts the query according to the stored language or setting. In adjusting the query, the stored language or locale setting is added to the query. The SQL command line processor 410 then sends the adjusted query to the database engine 402. Since the adjusted query contains the message table name for the specific locale, database engine 402 executes the query directly to obtain the resulting data. Database engine 402 returns the resulting data to the reporting or query tool 404.

Turning next to FIG. 4B, a diagram of database and table structure for enabling NLS of a database engine is depicted in accordance with a preferred embodiment of the present invention. This database and table structure is implemented using the components of the present invention as described in FIG. 4A.

As shown in FIG. 4B, the language or locale setting selected by the user when the user connects to the database engine, in this example “enus”, is stored in the LOCALE setting in command line processor 412. Message tables 414, 416 and 418 are different message tables that are created in the database engine to store different language or locale specific data 420, 422, and 424 are examples of internal table data for the message tables 414, 416, and 418, respectively.

Once the language or locale setting is set, the user may send a query to obtain data specific to that locale, in this case “enus”. The command line processor, as suggested by the present invention, processes the SQL query statement by modifying the message table name associated to the query based on the LOCALE setting. For this example, message table name “Citynames” is modified to Citynames_enus”. After the query is modified, the command line processor facilitates the selection of NLS by sending the query with stored locale setting 412 attached to the message table name. In this case, “Citynames_enus” 414 is the selected table based on the query and the locale setting. Finally, the mechanism of the present invention enables the execution of the user query in selected locale specific table 420 of the database engine.

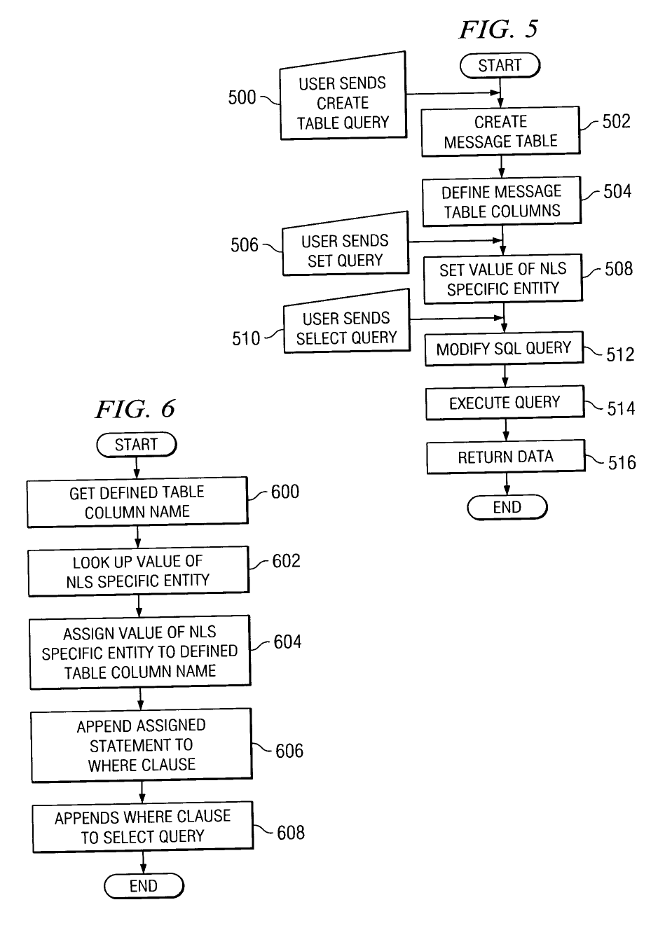

Turning next to FIG. 5, a flowchart of a process used in enabling NLS of a database engine by changing internal operation of the database engine to handle NLS is depicted in accordance with a preferred embodiment of the present invention. The process illustrated in FIG. 5 may be implemented in a process in a database engine, such as database engine 302 in FIG. 3.

As shown in FIG. 5, from the database engine's perspective, the process begins when a CREATE TABLE query is received as an input (step 500). The database engine creates a message table in response to the CREATE TABLE query (step 502). This message table includes a table column, containing the values that may be set by the user. In this example, the table column name is “Lang_id”.

Next, a table column is defined that can be set by the user's preference as value of the NLS Specific entity (step 504). For example, the “Lang_id” is defined as LOCALE, a NLS specific entity stored in the database engine. Once the table column name is defined, the NLS entity value will be used until the user redefines the table column name. A SET query to identify preference for a specific language or locale is received as input when a user connects to the database (step 506). An example SET query is as follows: SET LOCALE=“enus”. In this example, “enus” represents US English, which is the locale preference specified by the user.

The LOCALE entity's value is set to “enus” when the database engine processes the SET query (step 508). Later, a SELECT query is received when the user wants to retrieve data from the database engine (step 510). An example SELECT query is: SELECT Cityname FROM Citynames WHERE Zipcode=75240. From this query, “Cityname” is the name of the table column that contains resulting data. In this case, the name of the cities and “Citynames” is the name of the message table.

At this point, the SELECT statement of the query is modified to implicitly add or append additional conditions for the specified LOCALE preference (step 512). Once the database engine modifies the query, the query is executed by the database engine to obtain the resulting data (step 514). The resulting data is returned to the user (step 516) with the process terminating thereafter.

Next in FIG. 6, a flowchart of processing for modifying the SELECT query statement is depicted in accordance with a preferred embodiment of the present invention. The process shown in FIG. 6 is a more detailed description of step 512 in FIG. 5.

The process begins with the database engine obtaining the table column name defined in step 506 in FIG. 5 (step 600). As described in the above example, the table column name is “Lang_id”. The database engine then looks up the value of the corresponding NLS entity (step 602). In this case the value is “enus”, which was set in step 510 in FIG. 5. After a value of NLS entity is located, the value is assigned to the defined table column name (step 604). For the example described above, the assignment is Lang_id=“enus”.

After the assignment, the assignment statement is appended to the WHERE clause (step 606). The WHERE clause now becomes, WHERE Zipcode=75240 and Lang_id=“enus. Finally, the entire WHERE clause is appended to the SELECT statement of the query (step 608) with the process terminating thereafter. The resulting SELECT statement becomes, SELECT Cityname FROM Citynames WHERE Lang_id=“enus” and Zipcode=75240.

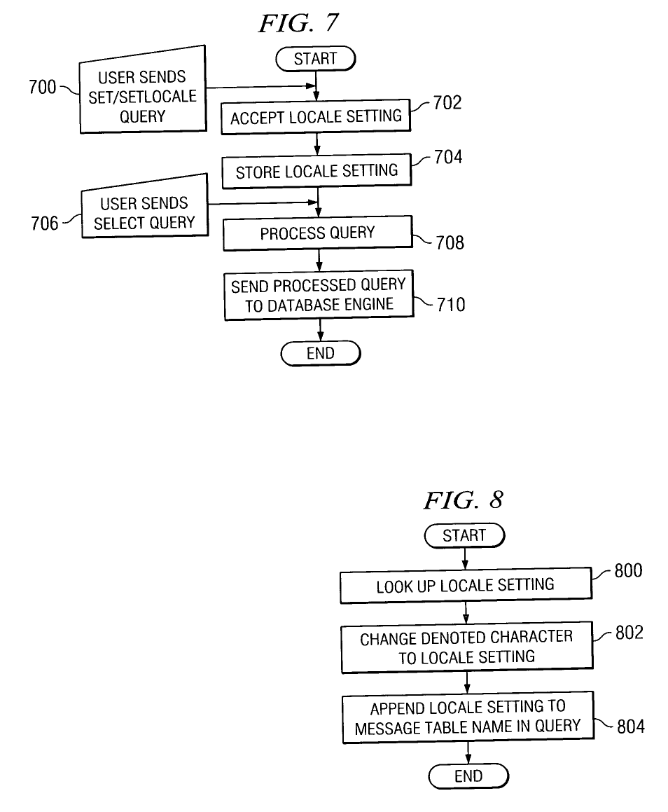

Turning next to FIG. 7, a flowchart of a process used in enabling NLS of a database engine by changing SQL command line processor to handle NLS is depicted in accordance with a preferred embodiment of the present invention. The process illustrated in FIG. 7 may be implemented in a process, reporting, or query tool such as reporting tool 404 in FIG. 4.

As illustrated in FIG. 7, from the SQL command line processor's perspective, the process begins by receiving a SET or SETLOCALE query to the SQL command line processor when the user connects to the database engine (step 700). An example SETLOCALE query is: SETLOCALE enus. When the SQL command line processor receives the query, the command line processor accepts the value of the locale specified by the user (step 702), in this example “enus”, and stores the value locally (step 704). A SELECT query is received by SQL command line processor from a user when the user wants to retrieve data from the database engine (step 706). For example, SELECT Cityname FROM Citynames$ WHERE City_id=1365. “Cityname” is the table column that contains the resulting data, a list of city names; the “$” character is a special character that the SQL command line processor uses in order to locate the message table that corresponds to a specific locale.

The SQL command line processor processes the query once it is received from the user (step 710). After the query is processed, the query is sent to the database engine for execution (step 712) with the process terminating thereafter.

Turning now to FIG. 8, a flowchart of processing for processing the SELECT query statement is depicted in accordance with a preferred embodiment of the present invention. The process shown in FIG. 8 is a more detailed description of step 708 in FIG. 7.

As described in FIG. 8, the SQL command line processor receives a SELECT query from the user to request for retrieval of data in step 710 in FIG. 7. From the above example, the SELECT query is SELECT Cityname FROM Citynames$ WHERE City_id=1365, where the “$” denotes a character that will be used by the SQL command line processor to specify the locale setting. The SQL command line processor begins to process the query by first looking up the value of the locale setting that is stored in step 706 in FIG. 7 (step 800). For the example described above, the locale setting is “enus”.

Next, the SQL command line processor replaces the “$” character inside the SELECT statement of the query with the stored locale setting (step 802). In this example, “$” is replaced with “enus”. The replaced string is then appended by the SQL command line processor to the message table name in the SELECT statement of the query (step 804). The processed SELECT statement now becomes: SELECT Cityname FROM Citynames_enus WHERE City_id=1365, in which “Cityname_enus” is the replaced string that represents the message table name where the US English translated city names are located in the database engine. Another example implementation of the present invention similar to the above may include defining a new SQL statement named SET, the SET statement reads: SET Citynames.Lang_id=“enus”. This statement becomes the locale reference of the database engine. When a SELECT query is submitted by the user, the above SET statement is implicitly added or appended to the WHERE clause of the SELECT query. In this case, the $ is not needed in the SELECT query because table column name is set explicitly in the SET statement. Therefore, the explicit setting may be applied to other column name such as Zipcode to set the Zipcode setting. In addition, this example implementation may add or append the WHERE clause by the Internal operation of the database engine, the SQL Command line processor or an external interface such as the JAVA JDBC interface.

In this manner the present invention provides an improved method, apparatus, and computer instructions for enabling language and locale support in a database engine. The first example implementation of the present invention described above changes the internal operations of the database engine by inserting additional conditions to the user's query automatically. The additional conditions are inserted once the language or locale is set by the user. This setting also is used throughout the database engine for other queries sent by the user. This illustrated method enables NLS message table to be selected by the database engine based upon the locale set by the user. The NLS selection reduces explicit NLS conditions for setting locale on a given query and reduces related queries if the locale setting is changed. This example method also provides a richer environment for reducing SQL query sets down to simpler queries that differs only in locale values set by the user.

In a second example implementation of the present invention, the SQL command line processor is configured to modify the user's query by appending the locale setting to the table column name of the message tables. This example implementation is relatively easy to implement, either as a separate program module or as part of user's reporting or query tool. In addition, this illustrated implementation does not affect the performance of the database engine because the SQL command line processor may be implemented outside of the database engine. Such an implementation does not interfere with the internal structure of the database engine. Furthermore, the goal of multidimensional modeling is achieved by this example because the SETLOCALE statement sent by the user can be used to determine which plane of the message table to load; each plane of the message table can represent a different perspective.

Thus, the present invention provides the ability to dynamically build and analyze multilingual and multicultural Unicode database without the need for user's intervention to adjust underlying queries and table in the database engine. By using the innovative features of the present invention, the effect of performance of the database engine is minimized as the number of language or locale increases. This innovative feature can be extended beyond NLS setting to cover any form of implicit table keys or selection such as using a DB2 like “register” variable.

The examples presented are for purposes of illustration and are not meant to limit the way in which the present invention may be implemented. The mechanism of the present invention may be implemented to set other conditions that are often referenced by user's queries in the reporting tool. Other context may be used. For example, a cultural context including a country, time zone, age, or date may be used in place of a language.

For example, if a user wants to run a sales report for a particular year in the reporting tool, the mechanism of the present invention can be used to set the year reference in the database engine for retrieving data associated to a particular year from the message tables. In addition, the SQL statement described by the mechanism of the present invention can be added to the SQL standard to enhance the SQL grammar for future use. Database vendors can also take advantage of the mechanism of the present invention to enhance the capabilities of their database tools where simpler user queries are implicitly modified.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for accessing a database containing text message for a plurality of cultural contexts, the method comprising:
receiving a request from a client to set a cultural context from the plurality of cultural contexts for the database; and
responsive to receiving queries from the client, processing the queries using the locale to select a text message in an appropriate cultural context without requiring the queries from the client to include the cultural context.

2. The method of claim 1, wherein the cultural context includes at least one of a language, a country, and a time zone.

3. The method of claim 1, wherein the database includes a plurality of message tables and wherein messages in the message tables are provided in the plurality of cultural contexts.

4. The method of claim 3, wherein multi-cultural text is stored in separate rows with a message ID and a cultural context ID.

5. The method of claim 4, wherein the cultural context ID is fixed based on the request.

6. The method of claim 4, wherein the cultural context ID is a language ID.

7. The method of claim 1, wherein the receiving step is located in one of a database engine and a command line parser.

8. The method of claim 1, wherein the cultural context is selected from one of a language, geographic location, age, year, or month.

9. A method in a data processing system for accessing a database containing text messages, the method comprising:
receiving a condition from a user to form a fixed condition;
maintaining the condition for the user with respect to queries to the database; and
responsive to receiving a query from the user after receipt of the request, processing the query using the fixed condition to select a text message without requiring the query to include the fixed condition.

10. The method of claim 9, wherein the fixed condition is selected from one of a language, geographic location, year, month, or age.

11. A data processing system for accessing a database containing text message for a plurality of cultural contexts, the data processing system comprising:
receiving means for receiving a request from a client to set a cultural context from the plurality of cultural contexts for the database; and
processing means, responsive to receiving queries from the client, for processing the queries using the locale to select a text message in an appropriate cultural context without requiring the queries from the client to include the cultural context.

12. The data processing system of claim 11, wherein the cultural context includes at least one of a language, a country, and a time zone.

13. The data processing system of claim 11, wherein the database includes a plurality of message tables and wherein messages in the message tables are provided in the plurality of cultural contexts.

14. A data processing system for accessing a database containing text messages, the data processing system comprising:
receiving means for receiving a condition from a user to form a fixed condition;
maintaining means for maintaining the condition for the user with respect to queries to the database; and
processing means, responsive to receiving a query from the user after receipt of the request, for processing the query using the fixed condition to select a text message without requiring the query to include the fixed condition.

15. The data processing system of claim 14, wherein the fixed condition is selected from one of a language, geographic location, year, month, or age.

16. A computer program product in a computer readable medium for accessing a database containing text message for a plurality of cultural contexts, the computer program product comprising:
first instructions for receiving a request from a client to set a cultural context from the plurality of cultural contexts for the database; and
second instructions, responsive to receiving queries from the client, for processing the queries using the locale to select a text message in an appropriate cultural context without requiring the queries from the client to include the cultural context.

17. The computer program product of claim 16, wherein the database includes a plurality of message tables and wherein messages in the message tables are provided in the plurality of cultural contexts.

18. A computer program product in a computer readable medium for accessing a database containing text messages, the computer program product comprising:
first instructions for receiving a condition from a user to form a fixed condition;
second instructions for maintaining the condition for the user with respect to queries to the database; and
third instructions for responsive to receiving a query from the user after receipt of the request, for processing the query using the fixed condition to select a text message without requiring the query to include the fixed condition.

19. A data processing system comprising:
a bus system;
a memory connected to the bus system, wherein the memory includes a set of instructions; and
a processing unit connected to the bus system, wherein the processing unit executes the set of instructions, to receive a request from a client to set a cultural context from the plurality of cultural contexts for the database and process the queries using the locale to select a text message in an appropriate cultural context in response to receiving queries from the client, without requiring the queries from the client to include the cultural context.

20. A data processing system comprising:
a bus system;
a memory connected to the bus system, wherein the memory includes a set of instructions; and
a processing unit connected to the bus system, wherein the processing unit executes the set of instructions to receive a condition from a user to form a fixed condition, maintain the condition for the user with respect to queries to the database and process the query using the fixed condition to select a text message in response to receiving a query from the user after receipt of the request, without requiring the query to include the fixed condition.
